(19) United States
(12) Patent Application Publication
(10) Pub. No.: US 2013/0194162 A1
(43) Pub. Date: Aug. 1, 2013

(54) DISPLAY DEVICE

(71) Applicant: Peter Autenzeller, Feldkirchen-Westerham (DE)

(72) Inventor: Peter Autenzeller, Feldkirchen-Westerham (DE)

(73) Assignee: GTG GmbH

(21) Appl. No.: 13/811,446

(22) PCT Filed: Jul. 25, 2011
(86) PCT No.: PCT/EP11/03717

§ 371 Date: Apr. 5, 2013

(30) Foreign Application Priority Data
Jul. 23, 2010 (DE) 20 2010 010 562.5

(51) Int. Cl. G09G 5/00

(52) U.S. Cl. CPC G09G 5/00
USPC 345/1.3

(57) ABSTRACT

The invention relates to a display device designed like a tower comprising display panels (11-19) which are arranged one over the other in levels (20, 21), are connected pivotably on each level like wings, and level by level can rotate independently of one another about a common vertical axis (29), with actuation means for folding and unfolding the display panels (11-19) level by level between a position in which the display panels (11-19) of a level come to rest, unfolded, in a common vertical plane, and a position in which the display panels, folded up, form the side surfaces of a prism, and for rotating the display panels (11-19) level by level.

The invention falls generally within the domain of advertising media, and in particular it relates to a device for the presentation of publicity in a novel manner based on display panels of conventional design.

It is known to use for audiovisual presentation purposes display panels in the form of screens and displays which are available as flat screens, especially LCD and TFT flat screens. These screens are used to present for example advertising messages in shops, at trade fairs and in public transport. These screens are generally installed stationarily at the target location and are provided with visual material and optionally also sound by a video player or a DVD player. Due to having been used, unchanged, for many years, this widely used type of presentation has lost much of its attraction because the public in question is accustomed to this type of presentation, not least because of the use of televisions in the home, and so it does not generally attract any particular attention any more.

Furthermore, EP 1463018 discloses an audiovisual presentation device with which visual and audio content is matched to the movement of the presentation medium—the screen. In this way the product being advertised is ever present and offers a highly efficient advertising platform. Since according to the invention the presentation medium in the form of the screen presents the people responsible for the presentation, it attracts the attention of the relevant public, be it expert groups or ultimate consumers, to such an extent that can not be achieved with the previous audiovisual presentation device with a static screen due to the effect of many years of familiarisation.

The latterly specified presentation device has proved its value in practical use. Nevertheless, there is a requirement for a presentation device based on display panels which can present publicity even more dynamically in a totally unfamiliar manner and can thus present it so that it appeals even more intensively to the target public.

It is therefore an object of the present invention to provide a display device in particular for advertising purposes which constitutes a highly efficient advertising platform.

This object is achieved by the features of claim 1. Advantageous further developments of the invention are specified in the sub-claims.

In other words, the invention accordingly provides a display device designed like a tower with display panels that can largely be moved individually and are arranged in a number of levels, the complex movement sequence of which can be matched to the content of the advertising messages, and thus provides a three-dimensional advertising medium that changes shape.

The display panels can be panels with static (advertising) content, e.g. in the form of printed matter. Particularly preferred, however, is the use of flat screens due to their dynamic visual content which can be adapted to the movement of the panels or which conversely controls the movement of the panels on the basis of their dynamic content.

In detail, the present invention provides a display device designed like a tower comprising display panels which are arranged one over the other in levels, are connected pivotably on each level like wings, and level by level can rotate independently of one another about a common vertical axis, with actuation means for folding and unfolding the display panels level by level between a position in which the display panels of a level come to rest, unfolded, in a common vertical plane, and a position in which the display panels, folded up, form the side surfaces of a prism, and for rotating the display panels level by level.

Preferably, the prism is a straight, particularly preferably a three-sided prism.

Advantageously, the display panels on each level are connected to a particular prismatic support structure which comes to rest within the prism that that the display panels define in the folded state.

In particular, not exclusively in the case of a three-sided prism however, one of the display panels is connected securely to the support structure while the display panels of the same level adjacent to this display panel on both sides are linked pivotably to the latter and optionally further display panels are in turn linked pivotably to these in order to fold and unfold.

Preferably the actuation means comprise piston/cylinder arrangements and/or lever arrangements for pivoting the display panels within a level and which are connected to the support structure and the display panel to be pivoted.

Preferably the drive means comprise an arrangement of concentric shafts aligned with the vertical axis of the levels for rotatably driving the support structure of the respective level and for folding and unfolding the display panels level by level.

Advantageously the display panel levels are placed on a base which has the same prism shape as the folded display panels of the individual levels.

Advantageously the visual contents of each display panel in unfolded display panels lying in one plane spread over a level constitute one cohesive large picture.

In the case of display panels in the form of flat screens, such as for example LCD displays, the overall visual content as the sum of the visual contents of the display panels controls the pivoting of the display panels and the rotation of their support structures.

In the case of flat screens, an electronic control device with a content player for actuating the drive means depending on the visual content is advantageously provided.

Moreover, the invention relates to an efficient arrangement for pivoting large-scale components according to claims 17 to 31 and the use of the latter for pivoting the display panels of the display device according to the invention.

In the following the invention is described in more detail by means of the drawings. These show as follows:

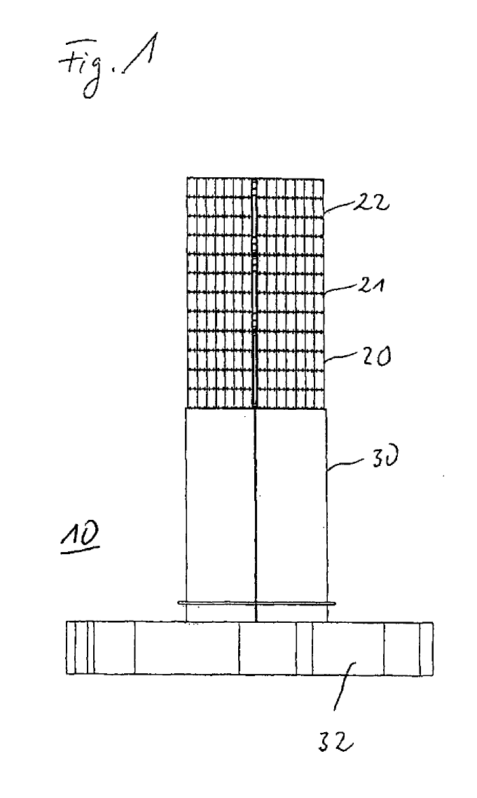

FIG. 1 a view of an embodiment of the display device according to the invention with display panels arranged on three levels, folded to form identical, three-sided prisms on each level in a rotational position in which the side surfaces of the three prisms are flush with one another to help form a common three-sided prism, as viewed looking at one prism edge,

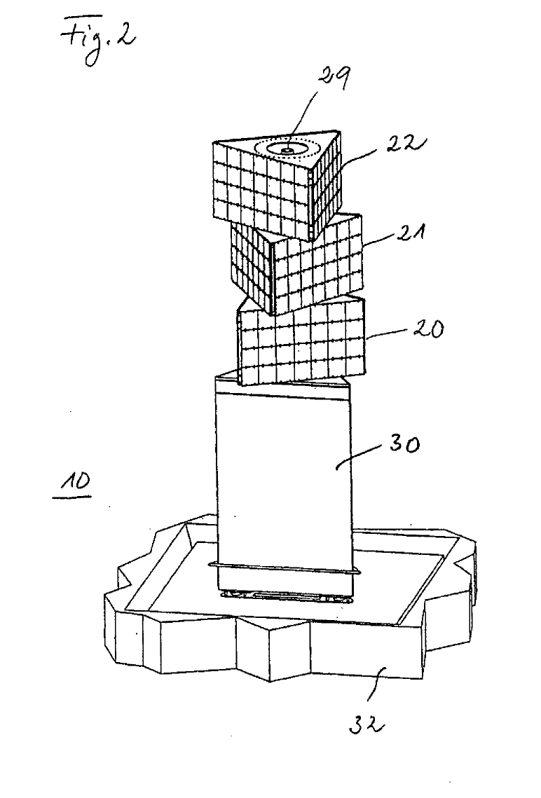

FIG. 2 the embodiment of the display device of FIG. 1 in a rotational position in which the three prisms come to rest rotated in relation to one another,

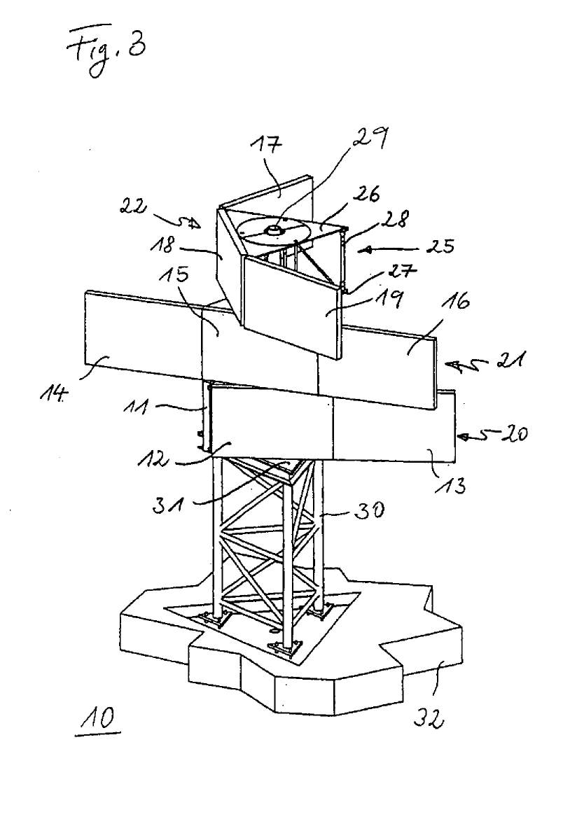

FIG. 3 the embodiment of the display device of FIGS. 1 and 2, in which the three display panels on the middle level come to rest in a common vertical plane in which on the lower level two display panels come to rest in a common plane, while the third display panel on this plane comes to rest tilted at the angle of the three-sided prism, and in which the two side display panels on the upper layer come to rest tilted at different angles to the central display panel which are greater than the prism angle,

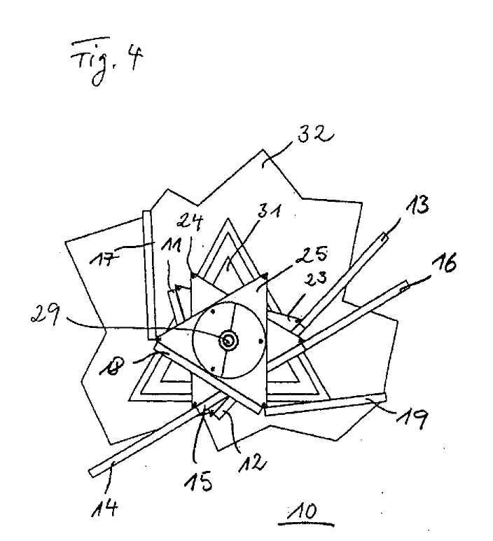

FIG. 4 a top view onto the display device in the display panel arrangement of FIG. 3,

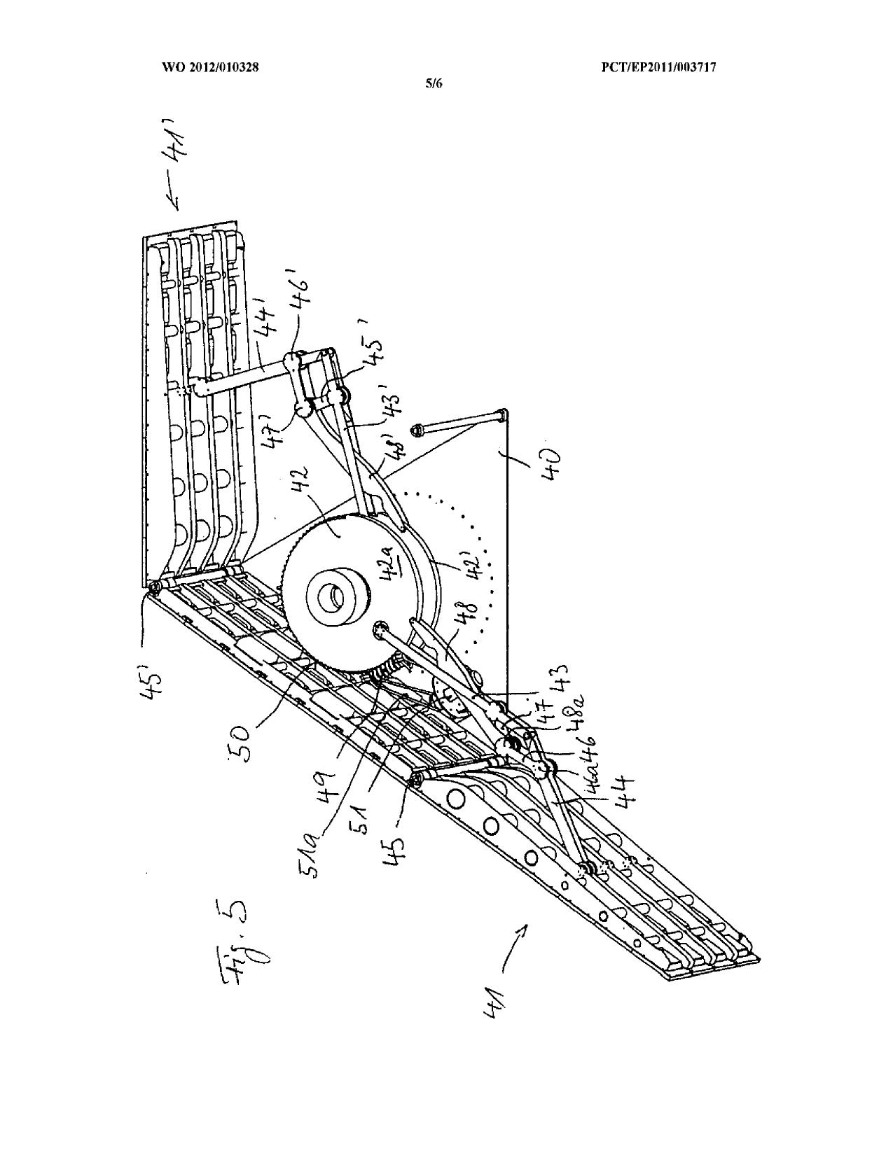

FIG. 5 an embodiment of an arrangement for pivoting at least one component arranged pivotably on a frame in a pivot plane and that is suitable for pivoting the display panels of the display device of FIGS. 1 to 4, the arrangement of the support structure of the display device corresponding to the frame, while the component corresponds to the arrangement of one of the display panels, and

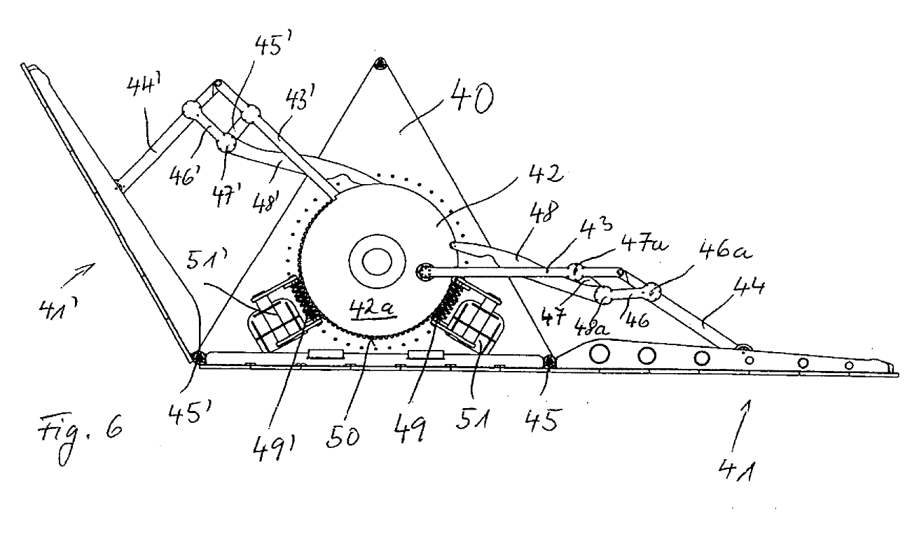

FIG. 6 a top view of the arrangement of FIG. 5.

The figures show an embodiment of a display device 10 designed like a tower comprising rectangular display panels 11, 12, 13; 14, 15, 16; 17, 18, 19 which are arranged on three levels, a lower level 20, a middle level 21 and an upper level 22, and which have the same rectangular dimensions. The same height of each level 20, 21, 22 corresponds to the length of the narrow sides of the display panels 11 to 19. Moreover, each level 20, 21, 22 comprises a support structure 23, 24, 25 in the form of the same straight three-sided prism.

As emerges from FIG. 3 with regard to the upper level 22, the prismatic support structure 25 of the latter is defined by an upper triangular plate 25 and a lower triangular plate 26 with identical edge lengths corresponding to the wide sides of the rectangular display panels 17, 18, 19 which are spaced apart from one another according to the height of the level and the length of the narrow sides of the display panels and are connected to one another rigidly by a framework of bars 28. The central display panel 18 is connected securely to the support structure 25, while the two adjacent display panels 17, 19 on both sides are connected flexibly to the central display panel 18 and can be pivoted by an actuation means (not shown) that comprises a hydraulically/pneumatically driven piston cylinder arrangement or a motor-driven lever mechanism or a spindle drive. The support structures 23 and 24 of the middle and lower levels 20 and 21 are identical in design to the support structure 22 of the upper level 22 and are connected to the display panels 11 to 19 of the respective level in the same way as in the case of the upper level. Moreover, a common vertically aligned shaft structure 29, on which the support structures are rotatably mounted individually and independently of one another, passes through the three support structures 22, 23 and 24. For this purpose, in a manner that is not shown, the shaft structure can include three independently driven coaxial shafts that are connected individually to the support structures. The shaft structure is anchored to the lower end in the centre of the upper platform 31 of a base 30 that is produced in the form of a framework and is anchored in the substrate 32, e.g. a concrete foundation, and has the same prism form as the support structures 22, 23, 24 of the three levels 20, 21, 22.

The side display panels 11, 13; 14, 16; 17, 19 can be pivoted by the actuation means in relation to the respectively central display panel 12; 15; 18 into any positions between two extreme positions-13 one extreme position in which all three display panels 11 to 13, 14 to 16 and 17 to 19 of one level 20 to 22 come to rest in a common vertical plane, as shown in FIGS. 3 and 4 for the middle level 21 by means of the display panels 14 to 16, and a position in which the side display panels rest against the corresponding support structure, as shown in FIGS. 1 and 2 for all three levels 20 to 22. An intermediate position between the two extreme positions is shown in FIGS. 3 and 4 for the upper level 25, and accordingly the one side display panel 17 comes to rest pivoted at a greater angle than the other side display panel 19 in relation to the central display panel 18. A further pivot position of the side display panels is shown in FIGS. 3 and 4 for the lower level 20. Accordingly the side display panel 11 rests against the corresponding support structure 23, while the side display panel 13 adopts a pivot position in which it comes to rest in a vertical plane with the central display panel 12.

Every side display panel can in principle adopt every position between the two extreme positions (open/closed). In addition, every plane 20, 21 and 22 can be rotated independently of one another about the shaft structure (central axis) as often as one wishes and without any restrictions, and so can adopt any position between 0° and 360°.

Moreover, FIGS. 2, 3 and 4 show rotational positions of the support structures 23, 24 and 25, different for each level, into which the latter are brought by the corresponding actuation means.

FIG. 1 shows the support structures 23, 24 and 25 of the three levels 20, 21 and 22 with side display panels 11, 13; 14, 16; 17, 19 placed constantly against the support structures in rotational positions in which all three side surfaces of the prism of each level thus closed are aligned with those of the other levels and come to rest in common vertical planes.

The display panels can contain motionless visual content, for example in the form of printed matter, on their outer viewing side. The visual contents of each display panel in display panels which lie unfolded and spread over the level in one plane can present one cohesive, large image.

Alternatively, the display panels can comprise moving visual content on the viewing side. In this case the display panels are preferably in the form of LED panels or flat screens or comprise the latter. Advantageously for the attractiveness of the display device shown in FIGS. 1 to 4, the visual contents of the individual display panels control the pivoting of the display panels and the rotation of their support structures. For this case the display device comprises a content player for actuating the drive means dependently upon the visual content.

The invention is not restricted to the embodiment of the display device described above as an example in straight prismatic form with a triangular base. In fact, a prism that does not extend in a straight line with a triangular base and a prism with more than three corners are possible. For example, with four corners, in this case it being possible to fix a central display panel to the corresponding support structure, or two adjacent display panels being able to be fixed to the latter. Further possibilities are polyhedra as geometric bodies delimited by a number of level surfaces, e.g. cuboids and pyramids, the support structures having corresponding geometries.

Furthermore, the invention is not restricted to a display device comprising three levels. In fact, the display device can basically comprise a single level and also two levels or more than three levels.

FIGS. 5 and 6 show an arrangement for pivoting at least one component (41) arranged on a frame (40) such at to be able to pivot in a pivot plane which, as can be seen from FIGS. 5 and 6, is suitable, without being restricted to this, for pivoting the display panels of the display device of FIGS. 1 to 4.

The pivot arrangement serves to pivot two display panels or components 41 and 41′ which are linked at the side to a stationary component, corresponding to a stationary display panel. In the following only the arrangement for pivoting the component 41 is described, the function for pivoting the other component 41′ working in the same way, and corresponding elements carrying the same reference numbers which are additionally identified by a

Every pivot arrangement comprises a five-limbed flat coupling mechanism 40-44 comprising a fixed coupling element formed by the frame 40, a first moveable coupling element 42 linked to a first fixed point of the frame 40 which is coupled by a second 43 and a third 44 moveable coupling element to a fourth moveable coupling element linked to a second fixed point 45 of the frame 40 and forming the pivotable component 41, the second and the third coupling links 43, 44 being supplemented by means of two auxiliary guides 46, 47 connected to the latter and to one another by articulated joints 46a, 47a to form a four-bar linkage 43, 44, 46, 47, and the articulated joint 48a connecting the auxiliary guides 46, 47 to one another being connected to the first moveable coupling element 42 by a control guide 48.

The first moveable coupling element 42 is connected to a pivot drive 49-51. The first moveable coupling element 42 is in the form of a circular disc or a circle segment disc 42a mounted rotatably on the frame 40, on the periphery of which is formed peripheral toothing 50 engaging with a worm shaft 49 as worm gearing. The worm shaft is made to rotate by an electric motor 51 by means of a belt 51a, by means of which the first coupling element 42 is rotationally driven by its peripheral toothing 50.

The second coupling element 43 is linked radially inwards from the peripheral edge to the rotatably mounted circular or circle segment disc 42a while the control guide 48 on the peripheral edge of the circular or circle segment disc is offset in the peripheral direction to the linkage point of the second coupling element 43 on this disc or the first coupling element 42. The linkage point of the control guide 48 lies in the non-toothed section of the peripheral edge of the circular or circle segment disc 42a.

The first, second and third coupling elements 42, 43, 44, the control guide 48 and the auxiliary guides 46, 47 are in the form of levers.

The second lever-shaped coupling element 43 is in the form of a fork, encompasses the circular or circle segment disc 42a on both sides and is linked to the latter by both ends. The control guide 48 passes through the fork-shaped second coupling element 43.

The control guide 48 is likewise in the form of a fork, encompasses the circular and circle segment disc 42a on the peripheral edge on both sides and is linked to the latter by both fork ends.

Similarly, the auxiliary guide 47 connected to the control guide 48 passes through the control guide 48 in the form of a fork.

The auxiliary guide 46 connected to the third coupling element 44 and the control guide 48 is made, like the fork-shaped lever elements described above, of two guide levers arranged spaced apart and congruently and which overlap the third coupling element 44 and the control guide at the respective connection point.

The lever-shaped third coupling element 44 consists of two congruently arranged lever parts.

The pivot arrangement shown in FIGS. 5 and 6 is characterised by high stability for precise work and makes it possible to pivot the component or display panel on the basis of an electric motor with relatively restricted power.

### LIST OF REFERENCE NUMBERS

10 display device
11 side display panel lower level
12 central display panel lower level
13 side display panel lower level
14 side display panel middle level
15 central display panel middle level
16 side display panel middle level
17 side display panel upper level
18 central display panel upper level
19 side display panel upper level
20 lower level
21 middle level
22 upper level
23 support structure lower level
24 support structure middle level
25 support structure upper level
26 upper triangular plate
27 lower triangular plate
28 framework of bars
29 shaft structure (central axis)
30 base
31 platform
32 substrate
40 frame
41 component
41a static component
42 first coupling element
42a circular or circle segment disc
43 second coupling element
44 third coupling element
45 second fixed point
46 auxiliary guide
46a articulated joint
47 auxiliary guide
47a articulated joint
48 control guide
48a articulated joint
49 worm shaft
50 peripheral toothing
51 electric motor
51a belt

1-31. (canceled)

32. A display device designed like a tower comprising display panels (11-19) which are arranged one over the other in levels (20, 21), are connected pivotably on each level like wings, and level by level can rotate independently of one another about a common vertical axis (29), with actuation means for folding and unfolding the display panels (11-19) level by level between a position in which the display panels (11-19) of a level come to rest, unfolded, in a common vertical plane, and a position in which the display panels, folded up, form the side surfaces of a prism, and for rotating the display panels (11-19) level by level.

33. The display device of claim 32, characterized in that the prism is a right prism.

34. The display device of claim 33, characterized in that the prism is a triangular prism.

35. The display device of claim 32, characterized in that the display panels (11-19) on each level are connected to a particular prismatic support structure (23, 24, 25) which comes to rest within the prism that the display panels (11-19) define in the folded state.

36. The display device of claim 35, characterized in that a display panel (12, 15, 18) is connected securely to the support structure (23, 24, 25) while the display panels of the same level adjacent to this display panel (12, 15, 18) on both sides are linked pivotably to the latter for folding and unfolding and optionally further display panels are in turn linked pivotably to these.

37. The display device according of claim 35, characterized in that the actuation means comprise piston/cylinder arrangements and/or lever arrangements for pivoting the display panels within a level and which are connected to the support structure (23-25) and the display panel (11-19) to be pivoted.

38. The display device according of claim 32, characterized in that the actuation means (23-25) comprise piston/cylinder arrangements for pivoting within a level the display panels (11-19) which are connected to the support structure and the display panel to be pivoted.

39. The display device of claim 35, characterized in that the drive means comprise an arrangement of concentric shafts aligned with the vertical axis of the levels (20-22) for rotatably driving the support structure (23-25) of the respective level and for folding and unfolding the display panels (11-19) level by level.

40. The display device of claim 32, characterized in that the display panel levels (20-22) are placed on a base which has the same prism shape as the folded display panels of the individual levels (20-22).

41. The display device according to claim 32, characterized in that the display panels (11-19) display motionless visual contents on their viewing side, for example in the form of printed materials.

42. The display device of claim 41, characterized in that the visual contents of each display panel (11-19) in unfolded display panels lying in one plane spread over a level constitute one cohesive large picture.

43. The display device of claim 32, characterized in that the display panels (11-19) comprise moving visual contents.

44. The display device of claim 43, characterized in that the display panels (11-19) comprise flat screens.

45. The display device of claim 44, characterized in that the visual content of the individual display panels (11-19) controls the pivoting of the display panels and the rotation of their support structures (23-25).

46. The display device of claim 45, characterized in that the overall visual content as the sum of the visual contents of all of the display panels (11-19) controls the pivoting of the display panels and the rotation of their support structures (23-25).

47. The display device of claim 45, characterized in that an electronic control device with a contenct player for actuating the drive means depending on the visual contenct is advantageously provided.

48. The display device of claim 32, further comprising an arrangement for pivoting at least one display (41) arranged pivotably in a pivot plane on a support structure (40), respectively comprising a five-limbed level coupling mechanism (40-44) comprising a fixed coupling element formed by the support structure (40), a first moveable coupling element formed by the support structure (40) which is coupled by a second (43) and a third (44) moveable coupling element to a fourth (44) moveable coupling element linked to a second fixed point (45) of the support structure (40) and forming the pivotable display device (41) the second and the third coupling elements (43, 44) being supplemented by means of two auxiliary guides (47, 48) connected flexibly to the latter and to one another to form a four-bar linkage (43, 44, 46, 47), and the articulated joint (48a) connecting the auxiliary guides (46, 47) to one another being connected to the first moveable coupling element (42) by a control guide (48).

49. The arrangement of claim 48, characterized in that the first moveable coupling element (42) is connected to a pivot drive (49-51).

50. The arrangement of claim 48, characterized in that the first moveable coupling element (42) is in form of a circular or circle sepment disc (42a) mounted rotatably on the frame (40), on the periphery of which is formed peripheral toothing (5) engaging with a driving toothed wheel (49).

51. The arrangement of claim 50, characterized in that the peripheral toothing (50) and the driving toothed wheel (49) form worm gearing (49).
